(19) United States
(12) Patent Application Publication
(10) Pub. No.: US 2026/0109160 A1
(43) Pub. Date: Apr. 23, 2026

(54) CONTROL DEVICE, IMAGE FORMING APPARATUS, AND DRIVE CONTROL METHOD

(71) Applicants: Shunsuke FUJIO, Kanagawa (JP); Motoharu TAKAHASHI, Kanagawa (JP); Hideaki SUZUKI, Kanagawa (JP); Yuki TAKAHASHI, Kanagawa (JP)

(72) Inventors: Shunsuke FUJIO, Kanagawa (JP); Motoharu TAKAHASHI, Kanagawa (JP); Hideaki SUZUKI, Kanagawa (JP); Yuki TAKAHASHI, Kanagawa (JP)

(73) Assignee: Ricoh Company, Ltd., Tokyo (JP)

(21) Appl. No.: 19/355,161

(22) Filed: Oct. 10, 2025

(30) Foreign Application Priority Data
Oct. 17, 2024 (JP) 2024-181826
Jun. 3, 2025 (JP) 2025-092767

(51) Int. Cl. B41J 11/00; B41J 13/22; B41J 25/308

(52) U.S. Cl. CPC B41J 11/008; B41J 11/0095; B41J 13/226; B41J 25/308

(57) ABSTRACT

A disclosed control device includes: a sensor configured to detect a transport abnormality of a recording medium transported while being wound around a cylindrical drum; and controller circuitry configured to control a position and a moving speed of a head unit equipped with liquid ejection heads that eject liquid onto the recording medium, wherein the controller circuitry controls the moving speed of the head unit when the sensor detects a transport abnormality of the recording medium.

### CROSS-REFERENCE TO RELATED APPLICATION

The present application claims priority under 35 U.S.C. § 119 to Japanese Patent Application No. 2024-181826, filed on Oct. 17, 2024, and Japanese Patent Application No. 2025-092767, filed on Jun. 3, 2025, the contents of which are incorporated herein by reference in their entirety.

### BACKGROUND OF THE INVENTION

### 1. Field of the Invention

The present disclosure relates to a control device, an image forming apparatus, and a drive control method.

### 2. Description of the Related Art

In an image forming apparatus, when a recording medium with a transport abnormality, such as lift, comes into contact with the nozzle surface of a liquid ejection head, foreign matter may adhere to the nozzle surface, possibly degrading ink ejection performance. A technique is disclosed in Patent Document 1 for retracting the liquid ejection head to a predetermined retracted position when lift of the transported recording medium is detected.

### RELATED-ART DOCUMENT

### Patent Document

Patent Document 1: WO2018/061939

### SUMMARY OF THE INVENTION

According to an aspect of the present disclosure, a control device includes: a sensor configured to detect a transport abnormality of a recording medium transported while being wound around a cylindrical drum; and controller circuitry configured to control a position and a moving speed of a head unit equipped with liquid ejection heads that eject liquid onto the recording medium, wherein the controller circuitry controls the moving speed of the head unit when the sensor detects a transport abnormality of the recording medium.

### BRIEF DESCRIPTION OF THE DRAWINGS

Other objects and further features of the present invention will be apparent from the following detailed description when read in conjunction with the accompanying drawings, in which:

FIG. 1 is a diagram illustrating a schematic configuration of an image forming apparatus according to a first embodiment of the present disclosure;

FIG. 2 is a diagram illustrating a schematic configuration of an image former in the image forming apparatus illustrated in FIG. 1;

FIG. 3 is a hardware configuration diagram of a control device according to the first embodiment of the present disclosure;

FIG. 4 is a block diagram illustrating a functional configuration of the control device according to the first embodiment of the present disclosure;

FIG. 5 is a flowchart illustrating a drive control method according to the first embodiment of the present disclosure;

FIG. 6 is a diagram illustrating a discharge position of a recording medium according to a second embodiment of the present disclosure; and

FIG. 7 is a flowchart illustrating a drive control method according to the second embodiment of the present disclosure.

### DESCRIPTION OF THE EMBODIMENTS

Even with a configuration as described in Patent Document 1, where the liquid ejection head is retracted after detecting a transport abnormality such as lift of the recording medium, there is a risk that the recording medium may reach the nozzle surface if the printing speed is increased. Consequently, the recording medium with a transport abnormality may contact the nozzle surface of the liquid ejection head, potentially damaging the head unit or the liquid ejection head.

Accordingly, it is desirable to provide a control device capable of preventing contact between a recording medium with a transport abnormality and a liquid ejection head.

In the control device according to the present disclosure, contact between a recording medium with a transport abnormality and the liquid ejection head can be prevented.

Hereinafter, embodiments of the present disclosure will be described with reference to the accompanying drawings. In each drawing, identical components are denoted by the same reference numerals, and redundant descriptions may be omitted.

### First Embodiment

### Configuration Example of Image Forming Apparatus 1

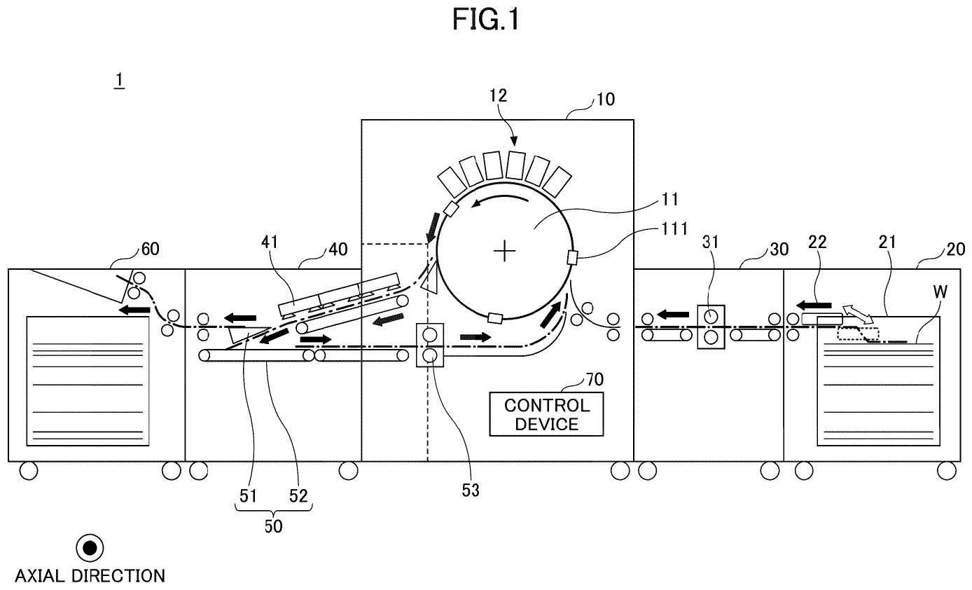

FIG. 1 is a diagram illustrating a schematic configuration of an image forming apparatus 1 according to a first embodiment of the present disclosure. The image forming apparatus 1 includes an image former 10, a paper feeder 20, a registration adjuster 30, a dryer 40, a recording medium inverter 50, and a first discharger 60, which are embodiments of the present disclosure.

The image forming apparatus 1 includes a control device 70. The control device 70 may be included in the image former 10, as illustrated, or in other components. Alternatively, the control device 70 may be an external device communicably connected to the image forming apparatus 1. The control device 70 controls the overall operation of the image forming apparatus 1.

In the image former 10, a head unit 12, which is a unit of liquid ejection heads that eject ink (an example of liquid) using an inkjet method, is arranged radially at an angle with predetermined ink colors filled, along the surface of a cylindrical drum 11. The cylindrical drum 11 holds and transports a recording medium W on the surface of the cylindrical drum 11.

The head unit 12 is equipped with liquid ejection heads that eject ink onto the recording medium W. The head unit 12 forms an image on the recording medium W by ejecting ink onto the outer peripheral surface of the recording medium W held on the surface of the cylindrical drum 11 from the outer side of the circumference.

The control device 70 also controls the operation of the head unit 12 by controlling the operation of a power source, such as a drive motor (not illustrated), that drives the head unit 12. The power source for the head unit 12 may be a stepping motor that rotates by a specified number of pulses. From the perspectives of preventing loss of synchronization in a stepping motor and enabling high-speed operation, it is preferable that the power source for the head unit 12 be a DC brushless motor or a DC motor.

The control of the head unit 12 employs position control for high-precision control. In position control, a specified number of pulses is provided to the power source of the head unit 12 while maintaining a constant pulse speed.

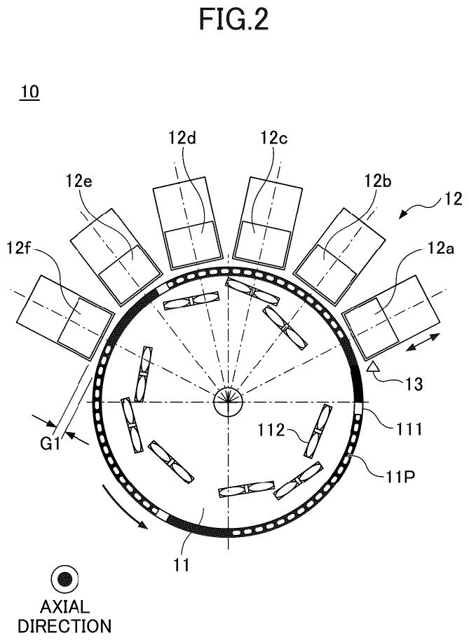

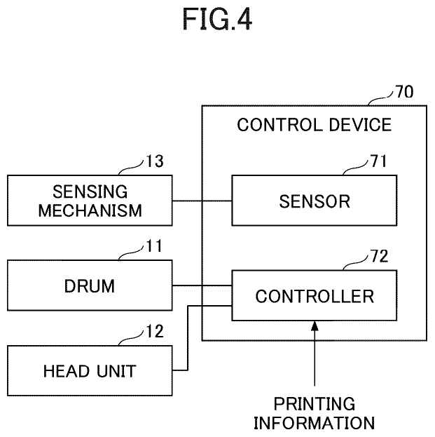

In the first embodiment, the control of the head unit 12 is performed not only by position control but also by speed control. Speed control is a control method in which, when a transport abnormality of the recording medium W is detected by a sensing mechanism 13 (described later with reference to FIG. 2), the head unit 12 moves at high speed in a direction away from the recording medium W, that is, in a radial direction substantially perpendicular to the outer peripheral surface of the cylindrical drum 11, based on a speed determined by a controller 72 illustrated in FIG. 4. It should be noted that the direction in which the head unit 12 moves away from the recording medium W does not need to be strictly perpendicular to the outer peripheral surface of the cylindrical drum 11, and it is sufficient insofar as the direction is generally perpendicular.

Next, the flow of the recording medium W during the execution of a print job in the image forming apparatus 1 will be described. First, the recording media W stacked in a paper feed stack 21 of the paper feeder 20 are picked up one sheet at a time by an air separator 22 and transported toward the image former 10.

When the recording medium W transported from the paper feeder 20 reaches the registration adjuster 30, the tilt of the recording medium W is corrected by a pair of registration rollers 31 provided inside the registration adjuster 30. The correction of the tilt of the recording medium W is also referred to as registration correction.

The registration-corrected recording medium W is sent to the image former 10, where the leading edge of the recording medium W is held by a recording medium gripper 111 provided on the surface of the cylindrical drum 11. As the cylindrical drum 11 rotates, the recording medium W is transported to a position facing the head unit 12.

When the recording medium W is transported under the head unit 12 arranged radially for each color, ink is ejected by the liquid ejection heads of the head unit 12, forming an image.

After the image is formed, the recording medium W is transported to the dryer 40. The dryer 40 is equipped with a dryer 41. The recording medium W passes under the dryer 41. The dryer 41 evaporates moisture in the ink on the recording medium W, thereby preventing curling of the recording medium W.

The dryer 40 is also provided with a recording medium inverter 50, which includes a recording medium inversion mechanism 51. For duplex printing, the recording medium inverter 50 inverts the recording medium W and transports it back toward the image former 10. When the transport direction of the recording medium W is switched in the recording medium inverter 50, an inversion transport unit 52 transports the recording medium W toward the image former 10. The tilt of the recording medium W is corrected by a pair of registration rollers 53 provided inside the image former 10 before reaching the cylindrical drum 11.

Then, in the image former 10, image formation is performed on the back side of the recording medium W. After image formation is completed on the desired side, the recording medium W passes through the dryer 40 again. Subsequently, the recording medium W is transported to the first discharger 60, and is stacked in an aligned state.

FIG. 2 is a diagram illustrating a schematic configuration of the image former 10 in the image forming apparatus 1 illustrated in FIG. 1. FIG. 2 illustrates the state of liquid ejection heads 12a to 12f when forming an image on the recording medium W. In this case, each of the liquid ejection heads 12a to 12f is arranged to maintain a predetermined gap G1 with respect to the surface of the cylindrical drum 11.

As illustrated in FIG. 2, the liquid ejection heads 12a to 12f are arranged radially at an angle with respect to the cylindrical drum 11. The liquid ejection heads 12a to 12f are arranged with a greater incline with respect to the vertical direction as they are positioned closer to sides of the cylindrical drum 11.

For example, the liquid ejection head 12a ejects black ink, the liquid ejection head 12b ejects cyan ink, the liquid ejection head 12c ejects magenta ink, and the liquid ejection head 12d ejects yellow ink. Additionally, the liquid ejection heads 12e and 12f may eject special color inks. Special color inks may include, for example, colors that cannot be expressed by the above four colors alone through ink mixing, colors containing gold or silver, fluorescent colors, or transparent coating liquids.

The liquid ejection heads 12a to 12f perform ascending and descending operations corresponding to a specified number of pulses. When the sensing mechanism 13 detects a transport abnormality of the recording medium W, the cylindrical drum 11 stops rotating, and the liquid ejection heads 12a to 12f retract by moving upward at a speed faster than the speed during normal operations, such as pre-printing operations or initial operations. Although an example is illustrated in which the head unit 12 includes six liquid ejection heads 12a to 12f, the number and positions of the liquid ejection heads 12a to 12f are not limited to the number and positions illustrated above.

On the outer peripheral surface of the cylindrical drum 11, a recording medium gripper 111, which is a claw member serving as a recording medium leading edge holding mechanism, is arranged to hold the leading edge of the recording medium W. Multiple recording medium grippers 111, which are claw members, are provided in the axial direction of the cylindrical drum 11 (the depth direction in FIG. 2), each enabling secure holding of the recording medium W by firmly clamping its leading edge.

Additionally, the surface of the cylindrical drum 11 is formed with numerous air suction holes 11P, and an air suction fan 112 provided inside the cylindrical drum 11 suctions the back surface of the recording medium W, allowing the recording medium W to adhere closely to the surface of the cylindrical drum 11. The air suction holes 11P and the air suction fan 112 function as a suction holding mechanism.

On the upstream side of the head unit 12 in the transport direction of the recording medium W, a sensing mechanism 13 is arranged to detect transport abnormalities of the recording medium W transported on the surface of the cylindrical drum 11. Transport abnormalities of the recording medium W include, for example, wrinkles, lift, or abnormalities of the recording medium W due to loss of synchronization of a stepping motor, but are not limited to these abnormalities described above.

The sensing mechanism 13 may include a laser displacement meter, an optical sensor, or other various sensors, but is not limited to those components described above. The sensing mechanism 13 may be positioned anywhere as long as it can detect transport abnormalities of the recording medium W with respect to the axial direction of the cylindrical drum 11. Multiple sensing mechanism 13 may be arranged with respect to the width of the recording medium W in the axial direction of the cylindrical drum 11.

### Configuration Example of Control Device 70

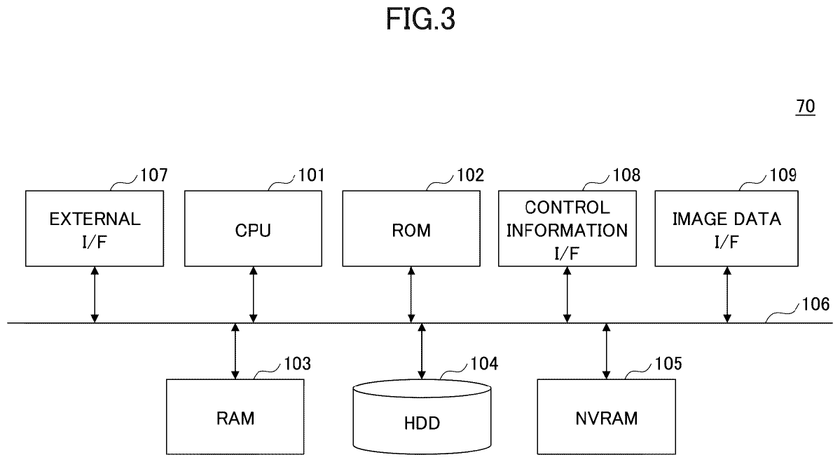

FIG. 3 is a hardware configuration diagram of the control device 70 according to the first embodiment of the present disclosure. A CPU (Central Processing Unit) 101, ROM (Read Only Memory) 102, RAM (Random Access Memory) 103, and a hard disk drive (HDD) 104 are connected to a bus 106. Additionally, an external I/F 107, a control information I/F 108, and an image data I/F 109 are connected to the bus 106. These components connected to the bus 106 are capable of communicating with each other via the bus 106.

The ROM 102 and HDD 104 store programs in advance for the operation of the CPU 101. The RAM 103 is used as a working memory for the CPU 101. Specifically, the CPU 101 uses the RAM 103 as a working memory in accordance with programs stored in the ROM 102 and HDD 104 to control the overall operation of the control device 70. The external I/F 107, for example, supports TCP/IP (Transmission Control Protocol/Internet Protocol) and controls communication with other devices. The control information I/F 108 controls the communication of control information.

The image data I/F 109 controls the communication of print image data and has multiple channels. For example, print image data for each color, including Y (yellow), C (cyan), M (magenta), and K (black) inks, created by the control device 70, is output through these multiple channels.

In this configuration, print job data sent from another device is received by the external I/F 107 of the control device 70 and stored in the HDD 104 via the CPU 101. The CPU 101 performs RIP (Raster Image Processing) based on the print job data read from the HDD 104, generates bitmap data for each color, and writes it to the RAM 103. For example, the CPU 101 renders PDL (Page Description Language) through RIP processing to generate bitmap data for each color and writes it to the RAM 103. The CPU 101 compresses and encodes the bitmap data for each color written to the RAM 103 and temporarily stores it in the HDD 104.

When, for example, a printing operation starts in the image forming apparatus 1, the CPU 101 reads the compressed and encoded bitmap data for each color from the HDD 104, decodes the compressed data, and writes the decompressed bitmap data for each color to the RAM 103. The CPU 101 then reads the bitmap data for each color from the RAM 103 and outputs it as print image data for each color through the respective channels of the image data I/F 109, supplying it to the image former 10. Additionally, the CPU 101 transmits and receives control information to and from the image former 10 via the control information I/F 108 in accordance with the progress of the printing operation.

NVRAM (Non-Volatile Random Access Memory) 105 stores various information related to the printer used by the programs stored in the ROM 102 and HDD 104.

FIG. 4 is a block diagram illustrating a functional configuration of the control device 70 according to the first embodiment of the present disclosure. The control device 70 includes a sensor 71 and the controller 72. The controller is an example of controller circuitry.

The sensor 71 detects a transport abnormality of the recording medium W on the cylindrical drum 11 that transports the recording medium W while winding the recording medium. The sensor 71 detects a transport abnormality of the recording medium W based on a signal output from the sensing mechanism 13 provided on the upstream side of the head unit 12 in the transport direction of the recording medium W. More specifically, the sensor 71 detects the presence or absence of a transport abnormality, such as lift, based on a threshold set according to the thickness or other properties of the recording medium W and notifies the controller 72. When a transport abnormality occurs, the controller 72 issues instructions for stopping the operation of the cylindrical drum 11 included in the image forming apparatus 1, as well as instructions for retraction and stopping operations of the head unit 12. Additionally, the controller 72 issues instructions for stopping operations or other actions to components other than the cylindrical drum 11 and the head unit 12 in conjunction with the instructions for the cylindrical drum 11 and the head unit 12.

The controller 72 controls the position and moving speed of the head unit 12, which is equipped with liquid ejection heads 12a to 12f that eject liquid onto the recording medium W. The controller 72 also controls the operation of the cylindrical drum 11.

When a transport abnormality occurs in the recording medium W, the controller 72 controls the moving speed of the head unit 12. More specifically, the controller 72 controls the head unit 12 in either a position control mode for controlling the position of the head unit 12 or a speed control mode for controlling the moving speed of the head unit 12. The controller 72 controls the head unit 12 in the speed control mode at least when a transport abnormality occurs in the recording medium W.

In the speed control mode, the controller 72 determines the moving speed of the head unit 12 based on printing information for controlling the operation of the head unit 12 and the operating speed of the power source of the head unit 12. The determined moving speed can be a value corresponding to the transport speed of the recording medium W. The printing information is, for example, information based on a print job received from a terminal device operated by a user, serving as the basis for the moving speed of the head unit 12 during printing.

Additionally, when a transport abnormality occurs in the recording medium W, it is preferable that the controller 72 controls the operations of the cylindrical drum 11 and the head unit 12 to perform a recovery operation for the recording medium W after resolving the transport abnormality, from the perspective of reducing jam processing time. When a transport abnormality occurs in the recording medium W, paper dust from the recording medium W often adheres to the cylindrical drum 11 or other components, so the recovery operation includes operations such as removing paper dust. Note that the recovery operation is not limited to paper dust removal but includes various operations for recovery.

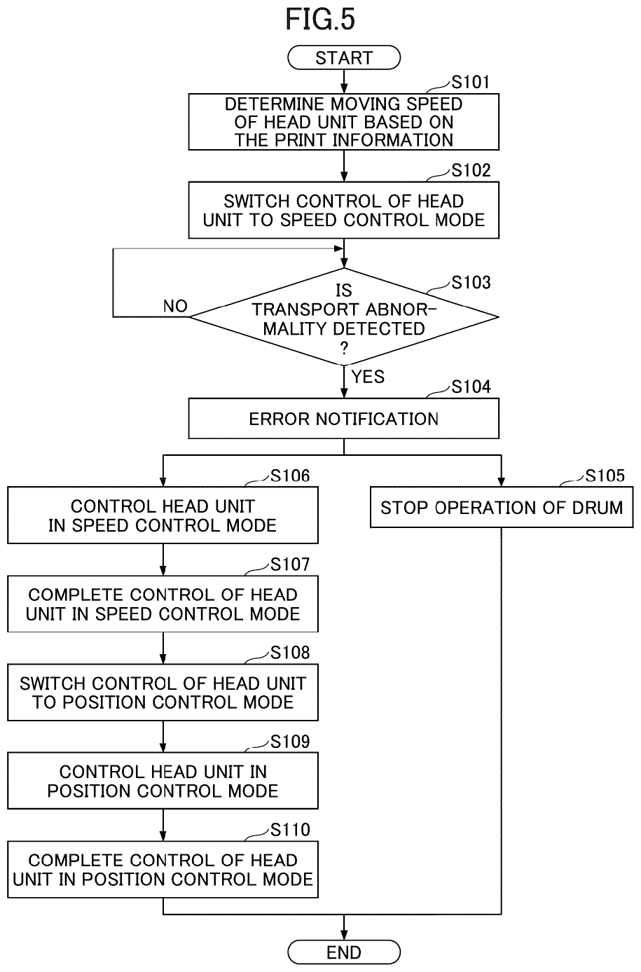

FIG. 5 is a flowchart illustrating a drive control method according to the first embodiment of the present disclosure. When the controller 72 of the control device 70 acquires printing information, the controller 72 determines the moving speed of the head unit 12 based on the printing information and notifies the head unit 12 of the determined moving speed (S101). Then, the controller 72 switches the control of the head unit 12 from position control mode to speed control mode (S102). The above processes are performed during the print preparation stage.

When printing starts, the sensor 71 detects a transport abnormality of the recording medium W based on a signal from the sensing mechanism 13 (S103). If no transport abnormality of the recording medium W is detected (S103: NO), the sensor 71 continues the process of detecting transport abnormalities of the recording medium W.

When a transport abnormality of the recording medium W is detected (S103: YES), the sensor 71 sends an error notification to the controller 72 (S104). At this time, the controller 72 stops the operation of the cylindrical drum 11 (S105) and controls the head unit 12 in speed control mode (S106). During this process, the head unit 12 moves at high speed in a direction away from the recording medium W based on the speed determined by the controller 72.

When the controller 72 stops the operation of the head unit 12, the controller 72 completes the control of the head unit 12 in speed control mode (S107). The controller 72 switches the control of the head unit 12 from speed control mode to position control mode (S108).

By switching to position control mode, the controller 72 moves the head unit 12 to a retracted position (S109). When the controller 72 stops the operation of the head unit 12, the controller 72 completes the control of the head unit 12 in position control mode (S110).

Through these steps, the drive control method according to one aspect of the present disclosure is implemented. However, the drive control method according to one aspect of the present disclosure may appropriately include other steps depending on measurement conditions, measurement environment, or the like.

In the control device 70 according to the first embodiment, the sensor 71 detects a transport abnormality of the recording medium W while the head unit 12 is switched to speed control mode. Therefore, when a transport abnormality of the recording medium W occurs, the operating speed of the head unit 12 can be increased, thereby preventing contact between the recording medium W with the transport abnormality and the liquid ejection heads 12a to 12f. By setting the determined moving speed to a value corresponding to the transport speed of the recording medium W, contact between the recording medium W with a transport abnormality and the liquid ejection heads 12a to 12f can be prevented even when the printing speed is further increased.

Additionally, the controller 72 can switch between a position control mode for controlling the position of the head unit 12 and a speed control mode for controlling the moving speed of the head unit 12. Therefore, even when a transport abnormality of the recording medium W occurs, the position control mode and speed control mode can be used selectively, allowing the head unit 12 to be moved to a desired position.

Furthermore, since the controller 72 determines the moving speed of the head unit 12 in speed control mode based on printing information for controlling the operation of the head unit 12 and the operating speed of the power source of the head unit 12, high-precision position control of the head unit 12 can be achieved using only speed control.

### Second Embodiment

Unlike the control device 70 according to the first embodiment, a control device 70 according to a second embodiment is configured such that upon detecting a transport abnormality of the recording medium W, the sensor 71 detects a lift amount of the recording medium W from the surface of the cylindrical drum 11. Additionally, the controller 72 moves the head unit 12 according to a movement amount of the head unit 12, which is determined based on the lift amount of the recording medium W from the surface of the cylindrical drum 11 detected by the sensor 71. Hereinafter, components identical to those already described above are denoted by the same reference numerals, and redundant descriptions are omitted.

The lift amount of the recording medium W from the surface of the cylindrical drum 11 is measured, for example, based on the results obtained by the sensing mechanism 13 illustrated in FIG. 2. The controller 72 controls the head unit 12 such that the greater the lift amount of the recording medium W, the larger the movement amount of the head unit 12.

Additionally, the controller 72 performs printing stop control to stop printing when the lift amount is equal to or greater than a threshold, and performs control to continue printing when the lift amount is less than the threshold. Printing stop control involves, for example, forcibly terminating printing when the lift amount equal to or greater than the threshold is detected. When the lift amount is less than the threshold, the controller 72 retracts the head unit 12 to a position at which the recording medium W can pass, returns the head unit 12 to its original position after the recording medium W has passed, and resumes printing. The determination of whether the lift amount is equal to or greater than the threshold is made by the sensor 71 but may also be made by the controller 72.

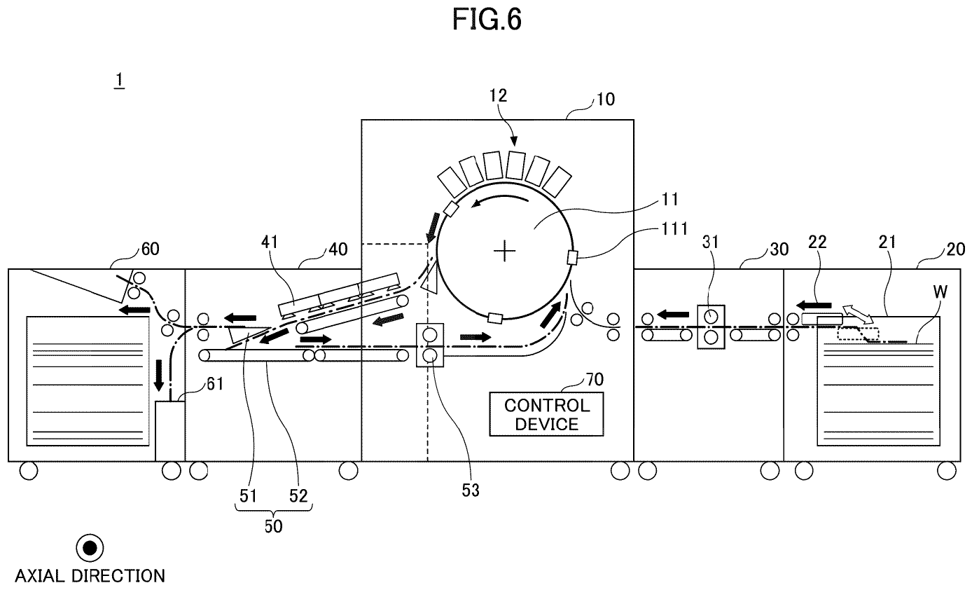

FIG. 6 is a diagram illustrating a discharge position of the recording medium W according to the second embodiment of the present disclosure. The illustrated image forming apparatus 1 includes a second discharger 61, in addition to the components illustrated in FIG. 1, namely, the image former 10, paper feeder 20, registration adjuster 30, dryer 40, recording medium inverter 50, and first discharger 60. Since the image former 10, paper feeder 20, registration adjuster 30, dryer 40, and recording medium inverter 50 are the same as those described above, their descriptions are omitted.

The controller 72 according to the second embodiment performs control to discharge a recording medium W, on which printing has not been completed due to printing stop control, and a recording medium W, on which printing has been completed through normal printing, to different discharge positions.

Recording media W on which printing has been completed through normal printing are discharged, for example, to a first discharger 60, while recording media W on which printing has not been completed due to printing stop control are discharged to a second discharger 61. However, the first discharger 60 and the second discharger 61, which correspond to respective discharge positions, are not limited to the positions illustrated above. The completion of printing through normal printing is not limited to the completion of printing due to the completion of a print job, but also includes, for example, the completion of printing due to an intermediate stop based on a user's instruction. Additionally, “not completed due to printing stop control” refers to a situation where printing is not completed due to printing stop control that stops printing when the lift amount is greater than the threshold.

By separating the discharge positions for the recording medium W on which printing has been completed through normal printing and the recording medium W on which printing has not been completed due to printing stop control, the effort of distinguishing between the recording medium W of which printing was completed normally and the recording medium W of which printing was forcibly terminated due to printing stop control is eliminated.

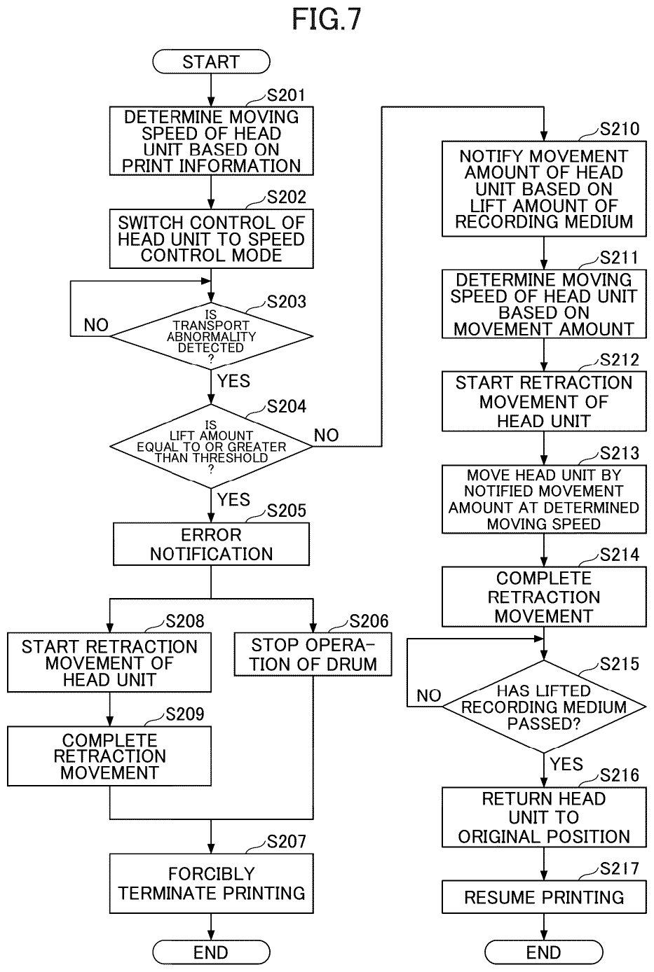

FIG. 7 is a flowchart illustrating a drive control method according to the second embodiment of the present disclosure. The processes in steps S201 to S203 are the same as those in steps S101 to S103 illustrated in FIG. 5, so descriptions thereof are omitted.

When the sensor 71 of the control device 70 determines that the lift amount of the recording medium W from the surface of the cylindrical drum 11 is equal to or greater than the threshold (S204: Yes), it sends an error notification to the controller 72 (S205). At this time, the controller 72 stops the operation of the cylindrical drum 11 (S206) and forcibly terminates printing (S207). Simultaneously, the controller 72 starts the retraction movement of the head unit 12 (S208) and completes the retraction movement when the head unit 12 reaches a predetermined position (S209). Then, the controller 72 forcibly terminates printing (S207).

When the lift amount of the recording medium W from the surface of the cylindrical drum 11 is less than the threshold (S204: No), the controller 72 notifies the power source such as a drive motor that drives the head unit 12 of the movement amount of the head unit 12 based on the lift amount of the recording medium W (S210). Additionally, the controller 72 determines the moving speed of the head unit 12 based on the movement amount (S211).

The controller 72 starts the retraction movement of the head unit 12 (S212). At this time, the power source, such as a drive motor, moves the head unit 12 by the notified movement amount at the determined moving speed based on instructions from the controller 72 (S213) and completes the retraction movement when the head unit 12 reaches a predetermined position (S214).

If the recording medium W has not passed (S215: No), the cylindrical drum 11 continues to operate until the recording medium W passes, and the head unit 12 waits at a position where the recording medium W can pass. When the recording medium W has passed (S215: Yes), the controller 72 returns the head unit 12 to its original position (S216) and resumes printing (S217), thereby continuing the printing control.

Through these steps, the drive control method according to the second embodiment of the present disclosure is implemented. However, the drive control method according to the second embodiment may appropriately include other steps depending on measurement conditions, measurement environment, or the like.

In the control device 70 according to the second embodiment, the head unit 12 is moved according to the movement amount of the head unit 12 determined based on the lift amount of the recording medium W detected when a transport abnormality is detected. Therefore, when the lift amount is small, the control device 70 can reduce the movement amount of the head unit 12, shortening the time required to return the head unit 12 to its original position, thereby reducing the time needed to resume printing operations.

Additionally, the control device 70 performs printing stop control to stop printing when the lift amount is equal to or greater than the threshold and performs control to continue printing when the lift amount is less than the threshold. Therefore, when the lift amount is small, the control device 70 can retract the head unit 12 without stopping the transport of the recording medium W, thereby reducing the time required to resume printing operations.

Although the embodiments have been described above, the present disclosure is not limited to the embodiments described above, and various modifications and improvements are possible within the scope of the present disclosure.

Each function of the embodiments described above can be implemented by one or more processing circuits. In this specification, a “processing circuit” or “circuitry” such as controller circuitry includes a processor programmed to execute each function by software, such as a processor implemented by electronic circuits, as well as devices such as an ASIC (Application Specific Integrated Circuit), DSP (Digital Signal Processor), FPGA (Field Programmable Gate Array), or conventional circuit modules designed to execute the functions described above.

Aspects of the present disclosure are, for example, as follows:
<1> A control device comprising:
a sensor configured to detect a transport abnormality of a recording medium transported while being wound around a cylindrical drum; and
controller circuitry configured to control a position and a moving speed of a head unit equipped with liquid ejection heads that eject liquid onto the recording medium,
wherein the controller circuitry controls the moving speed of the head unit when the sensor detects a transport abnormality of the recording medium.
<2> The control device according to <1>, wherein the controller circuitry is configured to control the head unit in either a position control mode for controlling a position of the head unit or a speed control mode for controlling a moving speed of the head unit, and is configured to control the head unit in the speed control mode at least when the sensor detects a transport abnormality of the recording medium.
<3> The control device according to <2>, wherein in the speed control mode, the controller circuitry is configured to determine a moving speed of the head unit based on printing information for controlling an operation of the head unit and an operating speed of a power source of the head unit.
<4> The control device according to <3>, wherein in the speed control mode, the controller circuitry is configured to operate a the head unit to retract at a speed faster than a moving speed of the head unit during normal operation.
<5> The control device according to <3> or <4>, wherein the power source of the head unit is a DC brushless motor or a DC motor.
<6> The control device according to any one of <1> to <5>, wherein when the sensor detects a transport abnormality of the recording medium, the controller circuitry is configured to control operations of the cylindrical drum and the head unit to perform a recovery operation for the recording medium after resolving the transport abnormality.
<7> The control device according to <1>, wherein the sensor is configured to detect a lift amount of the recording medium from a surface of the cylindrical drum when the sensor detects the transport abnormality, and
the controller circuitry is configured to move the head unit according to a movement amount of the head unit determined based on the lift amount.
<8> The control device according to <7>, wherein the controller circuitry is configured to perform a printing stop control to stop printing when the lift amount is equal to or greater than a threshold, and is configured to perform a control to continue printing when the lift amount is less than the threshold.
<9> The control device according to <8>, wherein the controller circuitry is configured to control discharge of the recording medium such that a recording medium on which printing has not been completed due to the printing stop control and a recording medium on which printing has been completed through normal printing are discharged to different discharge positions.
<10> An image forming apparatus comprising:
a cylindrical drum configured to transport a recording medium while winding the recording medium around the cylindrical drum;
a head unit equipped with liquid ejection heads that eject liquid onto the recording medium;
controller circuitry configured to control a position and a moving speed of the head unit; and
a sensor configured to detect a transport abnormality of the recording medium on the cylindrical drum,
wherein the controller circuitry controls the moving speed of the head unit when the sensor detects a transport abnormality of the recording medium.
<11> A drive control method executed by a control device, the drive control method comprising:
detecting a transport abnormality of a recording medium transported while being wound around a cylindrical drum;
controlling a position and a moving speed of a head unit equipped with liquid ejection heads that eject liquid onto the recording medium; and
controlling the moving speed of the head unit when the sensor detects a transport abnormality of the recording medium.

Further, the present disclosure is not limited to these embodiments described above, and various variations and modifications may be made without departing from the scope of the present disclosure.

What is claimed is:

1. A control device comprising:
a sensor configured to detect a transport abnormality of a recording medium transported while being wound around a cylindrical drum; and
controller circuitry configured to control a position and a moving speed of a head unit equipped with liquid ejection heads that eject liquid onto the recording medium,
wherein the controller circuitry controls the moving speed of the head unit when the sensor detects a transport abnormality of the recording medium.

2. The control device according to claim 1, wherein the controller circuitry is configured to control the head unit in either a position control mode for controlling a position of the head unit or a speed control mode for controlling a moving speed of the head unit, and to control the head unit in the speed control mode at least when the sensor detects a transport abnormality of the recording medium.

3. The control device according to claim 2, wherein in the speed control mode, the controller circuitry is configured to determine a moving speed of the head unit based on printing information for controlling an operation of the head unit and an operating speed of a power source of the head unit.

4. The control device according to claim 3, wherein in the speed control mode, the controller circuitry is configured to operate the head unit to retract at a speed faster than a moving speed of the head unit during normal operation.

5. The control device according to claim 3, wherein the power source of the head unit is a DC brushless motor or a DC motor.

6. The control device according to claim 1, wherein when the sensor detects a transport abnormality of the recording medium, the controller circuitry is configured to control operations of the cylindrical drum and the head unit to perform a recovery operation for the recording medium after resolving the transport abnormality.

7. The control device according to claim 1, wherein the sensor is configured to detect a lift amount of the recording medium from a surface of the cylindrical drum when the sensor detects the transport abnormality, and
the controller circuitry is configured to move the head unit according to a movement amount of the head unit determined based on the lift amount.

8. The control device according to claim 7, wherein the controller circuitry is configured to perform a printing stop control to stop printing when the lift amount is equal to or greater than a threshold, and is configured to perform a control to continue printing when the lift amount is less than the threshold.

9. The control device according to claim 8, wherein the controller circuitry is configured to control discharge of the recording medium such that a recording medium on which printing has not been completed due to the printing stop control and a recording medium on which printing has been completed through normal printing are discharged to different discharge positions.

10. An image forming apparatus comprising:
a cylindrical drum configured to transport a recording medium while winding the recording medium around the cylindrical drum;
a head unit equipped with liquid ejection heads that eject liquid onto the recording medium;
controller circuitry configured to control a position and a moving speed of the head unit; and
a sensor configured to detect a transport abnormality of the recording medium on the cylindrical drum,
wherein the controller circuitry controls the moving speed of the head unit when the sensor detects a transport abnormality of the recording medium.

11. A drive control method executed by a control device, the drive control method comprising:
detecting a transport abnormality of a recording medium transported while being wound around a cylindrical drum;
controlling a position and a moving speed of a head unit equipped with liquid ejection heads that eject liquid onto the recording medium; and
controlling the moving speed of the head unit when the sensor detects a transport abnormality of the recording medium.
